(19) United States
(12) Patent Application Publication
(10) Pub. No.: US 2025/0332604 A1
(43) Pub. Date: Oct. 30, 2025

(54) MULTIFUNCTIONAL SPRAY GUN

(71) Applicant: ZHUHAI MAXTOR ENTERPRISE CO., LTD., Zhuhai (CN)

(72) Inventor: Huayun WEI, Zhuhai (CN)

(21) Appl. No.: 19/260,453

(22) Filed: Jul. 5, 2025

Related U.S. Application Data
(63) Continuation of application No. PCT/CN2024/093800, filed on May 17, 2024.

(30) Foreign Application Priority Data
Jul. 5, 2023 (CN) 202321755704.0

(51) Int. Cl. B05B 11/10; B05B 7/00; B05B 11/02; B05B 12/00; B05B 15/65

(52) U.S. Cl. CPC B05B 11/1004; B05B 7/005; B05B 11/025; B05B 12/0022; B05B 15/65

(57) ABSTRACT

The present disclosure relates to the technical field of liquid sprayers, and more particularly to a multifunctional spray gun. The spray gun comprises a handle designed for single-hand four-finger ergonomic gripping and a pressing plate configured for single-hand thumb depression. The handle and the pressing plate are hingedly connected to enable more labor-saving and convenient single-handed operation. Additionally, a spray nozzle is detachably connected to the spray gun's discharge end to atomize liquid for spraying applications. Simultaneously, a foam spray head is detachably connected to the spray nozzle, converting atomized liquid from the spray nozzle into foam to achieve foam discharge requirements. When foam functionality is unnecessary, the foam spray head can be removed. Further, when atomization is unnecessary, the spray nozzle can be detached to discharge liquid only. The above design satisfies diverse liquid-discharging requirements across different scenarios, providing multifunctionality and convenient operation.

### CROSS-REFERENCE TO RELATED APPLICATIONS

This application is a continuation of International Application No. PCT/CN2024/093800, filed on May 17, 2024, which claims priority to Chinese Patent Application No. 202321755704.0, filed on Jul. 5, 2023. All of the aforementioned applications are incorporated herein by reference in their entireties.

### TECHNICAL FIELD

The present disclosure relates to the technical field of liquid sprayers, and more particularly to a multifunctional spray gun.

### BACKGROUND

Existing plastic spray guns in the market, widely used for public and household environment disinfection, kitchen/toilet cleaning sprays, horticulture, and floral applications, typically employ a trigger-driven design. Operation requires the index finger to pull the trigger while the remaining fingers and thumb of the same hand grasp the upper portion of the container. Although operable with one hand, this design is relatively laborious due to the need to simultaneously grip the container with the thumb and the web between thumb and index finger (thenar web space) while depressing the trigger with the index finger and several other fingers to perform liquid-pumping operations. Furthermore, constrained by the gripping mechanism, compatible containers are generally small-capacity, thus being unsuitable for larger-capacity bottles and resulting in poor consumer experience. Conventional plastic spray guns generally offer only a single spray function, failing to meet the application requirements for foam spraying in many scenarios, or they are only capable of foam discharge while being unable to satisfy atomization needs. Existing spray guns therefore suffer from limited application scenarios.

### SUMMARY

To overcome the drawbacks of inconvenient one-handed operation and limited functionality in prior spray guns, the present disclosure provides a multifunctional spray gun. The technical solution adopted is as follows:

A multifunctional spray gun, comprising: a locking cover mechanism, wherein a handle is fixedly connected to the locking cover mechanism; a liquid spraying mechanism, wherein the liquid spraying mechanism comprises a connection end and a spray rod in fluid communication internally, the connection end is slidably disposed in the locking cover mechanism, and the spray rod extends outward from the locking cover mechanism; a pressing plate, wherein the pressing plate is hinged to the liquid spraying mechanism and abuts against an upper portion of the connection end, and the pressing plate and the handle are oriented in the same direction; a pumping mechanism, wherein the pumping mechanism comprises a liquid suction chamber, the liquid suction chamber is coaxially fixed to the locking cover mechanism, a pump assembly is slidably disposed in the liquid suction chamber, an upper end of the pump assembly is in interference fit with the connection end, a lower end of the pump assembly abuts against a return spring, and the pumping mechanism is configured to perform reciprocating actions for pumping liquid/gas; a cap, wherein the cap is rotatably disposed between the locking cover mechanism and the liquid suction chamber, and the cap is detachably connected to a liquid container; a spray nozzle, wherein the spray nozzle is detachably sleeved on a front end of the spray rod, and a spray core is disposed in the spray nozzle to atomize ejected liquid; and a foam spray head, wherein the foam spray head is detachably sleeved on a front end of the spray nozzle, a foam chamber is formed in the foam spray head, and an air intake hole is provided on a periphery of the foam spray head to communicate the foam chamber with an external environment, thereby foaming atomized liquid.

Further, a foam-flip cover is hinged to a front end of the foam spray head, and a foam grid is provided on the foam-flip cover to further foam the atomized liquid.

Further, a buckle strip is provided on a periphery of the foam-flip cover, and a protrusion is provided on a corresponding position of the periphery of the foam spray head to engage with the buckle strip in a snap-fit connection.

Further, a locking cover snap-fit is provided at a lower end of the locking cover mechanism, a pump snap-fit is provided at an upper end of the liquid suction chamber, and the locking cover snap-fit and the pump snap-fit are engaged to detachably fix the locking cover mechanism to the liquid suction chamber.

Further, the pump assembly comprises: a first pump column, having a tubular structure, wherein an outer wall of an upper end of the first pump column is in interference fit with an inner wall of the connection end, and a first limiting member is fixed to the outer wall of the first pump column; a second pump column, having a tubular structure, wherein an outer wall of an upper end of the second pump column is in interference fit with an inner wall of the first pump column, a second limiting member is fixed to the outer wall of the second pump column, a bottom end of the second pump column is sealed and abuts against the return spring, and a liquid inlet is formed in a side wall of the second pump column; and a piston, wherein the piston is disposed in the liquid suction chamber and sleeved on the outer walls of the first pump column and the second pump column, the piston is positioned between the first limiting member and the second limiting member, the first pump column and the second pump column are slidable relative to the piston, a maximum sliding stroke equals a distance between the first limiting member and the second limiting member, liquid is blocked from entering through the liquid inlet when the piston abuts against the second limiting member, and the return spring biases the second pump column to move upward relative to the piston, thereby driving the second limiting member to abut against the piston.

Further, a suction tube is connected to a lower end of the liquid suction chamber and extends to a bottom of the liquid container, a V-shaped orifice is formed at the lower end of the liquid suction chamber, and a ball valve is movably disposed in the V-shaped orifice, wherein a diameter of the ball valve is greater than a diameter of a lower port of the V-shaped orifice to prevent liquid backflow from the liquid suction chamber into the suction tube.

Further, the handle and the pressing plate are oriented in the same direction, a pivot hole is provided on the locking cover mechanism, a protruding shaft is provided on the pressing plate, and the pressing plate is hinged to the locking cover mechanism via engagement between the protruding shaft and the pivot hole.

Further, the spray gun further comprises an external brake clamp, wherein the brake clamp is clampable between the pressing plate and an upper platform of the handle to restrict depression of the pressing plate.

The beneficial effects of the present disclosure are:
The spray gun comprises a handle designed for single-hand four-finger ergonomic gripping and a pressing plate configured for single-hand thumb depression. The handle and the pressing plate are hingedly connected to enable more labor-saving and convenient single-handed operation. Additionally, a spray nozzle is detachably connected to the spray gun's discharge end to atomize liquid for spraying applications. Simultaneously, a foam spray head is detachably connected to the spray nozzle, converting atomized liquid from the spray nozzle into foam to achieve foam discharge requirements. When foam functionality is unnecessary, the foam spray head can be removed. Further, when atomization is unnecessary, the spray nozzle can be detached to discharge liquid only. The above design satisfies diverse liquid-discharging requirements across different scenarios, providing multifunctionality and convenient operation.

### BRIEF DESCRIPTION OF THE DRAWINGS

The present disclosure is further described below with reference to the accompanying drawings and embodiments, wherein:

FIG. 1 is a cross-sectional view of the spray gun of the present disclosure;

FIG. 2 is a cross-sectional view of the spray gun assembled with the spray nozzle of the present disclosure;

FIG. 3 is a cross-sectional view of the spray gun assembled with the foam spray head of the present disclosure;

FIG. 4 is a partially enlarged view of Area A in FIG. 1 of the present disclosure;

FIG. 5 is a partially enlarged view of Area B in FIG. 2 of the present disclosure;

FIG. 6 is a partially enlarged view of Area C in FIG. 3 of the present disclosure;

FIG. 7 is a cross-sectional view of the locking cover assembly of the present disclosure;

FIG. 8 is a top view of the pressing plate of the present disclosure;

FIG. 9 is a cross-sectional view of the discharge head of the present disclosure;

FIG. 10 is a perspective view of the foam spray head of the present disclosure;

FIG. 11 is a cross-sectional view of the pumping mechanism of the present disclosure.

### REFERENCE NUMERALS

100, locking cover mechanism; 101, handle; 102, pivot hole; 103, locking cover snap-fit;
200, pressing plate; 201, protruding shaft;
300, liquid spraying mechanism; 301, connection end; 302, spray rod;
400, foam spray head; 401, air intake hole; 402, foam-flip cover; 403, foam grid; 404, foam chamber; 405, buckle strip; 406, protrusion;
500, pumping mechanism; 501, liquid suction chamber; 502, suction tube; 503, pump snap-fit; 504, first pump column; 5041first limiting member; 505, second pump column; 5051, liquid inlet; 5052, second limiting member; 506, piston; 507, return spring; 508, ball valve; 509, V-shaped orifice;
600, cap; 601, convex thread;
700, spray nozzle; 701, spray core; and
800, brake clamp.

### DETAILED DESCRIPTION OF THE EMBODIMENTS

To better understand the objectives, structure, and functions of the present disclosure, the following describes a multifunctional spray gun in detail with reference to the accompanying drawings.

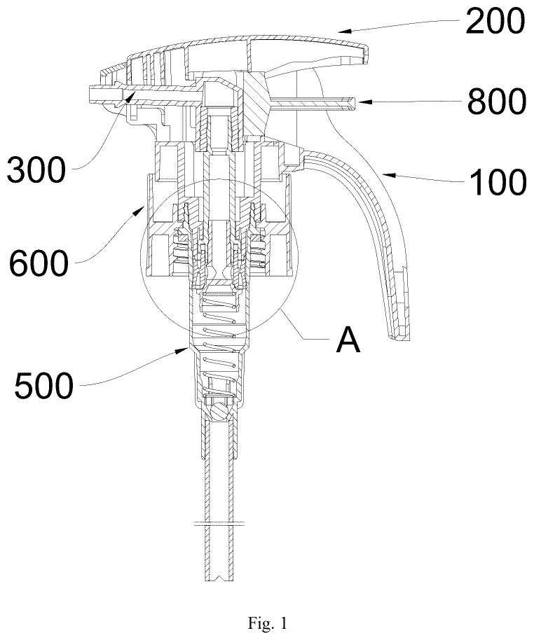

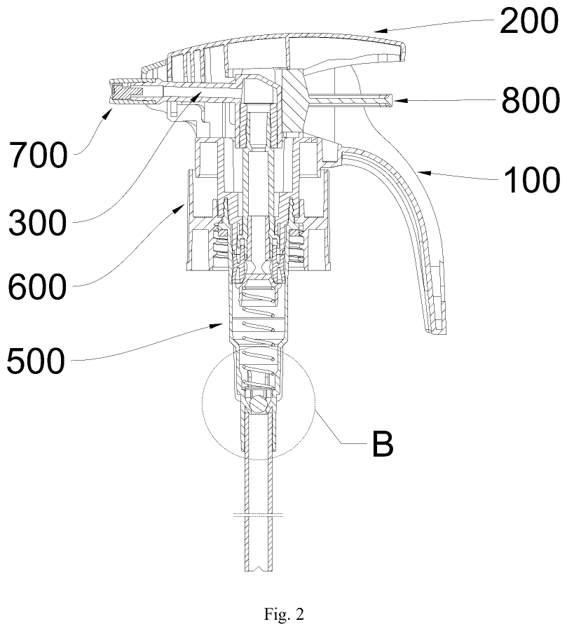

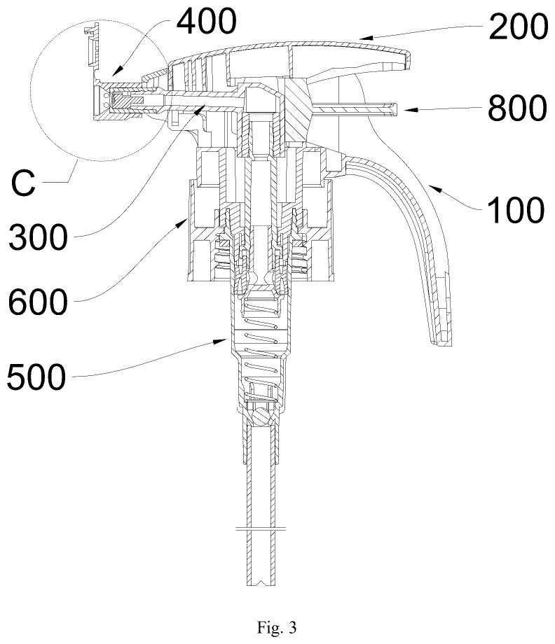

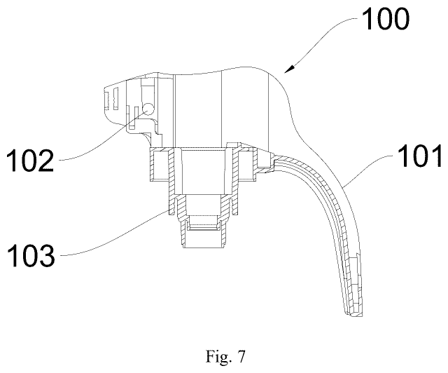

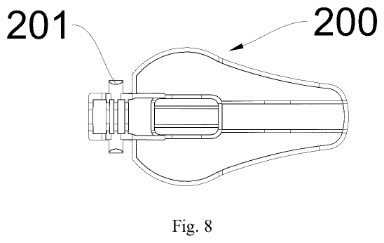

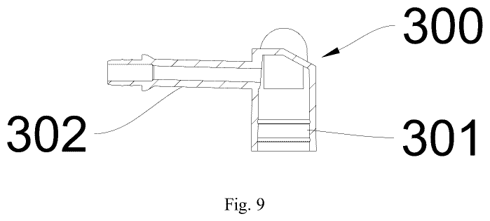

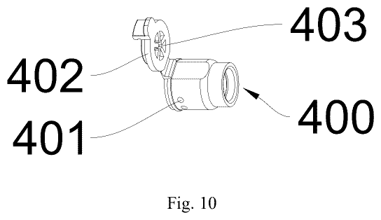

Referring to FIGS. 1-11, the spray gun includes a locking cover mechanism 100. A handle 101 is fixedly connected to the locking cover mechanism 100 for single-handed gripping. A liquid spraying mechanism 300 is disposed in the locking cover mechanism 100. The liquid spraying mechanism 300 includes a connection end 301 and a spray rod 302 in fluid communication internally. The connection end 301 is disposed in the locking cover mechanism 100 and is slidably movable relative to the locking cover mechanism 100. The spray rod 302 extends outward from the locking cover mechanism 100 to spray liquid. A pivot hole 102 is further provided on the locking cover mechanism 100. A pressing plate 200 is hinged to the locking cover mechanism 100 through the cooperation of a protruding shaft 201 and the pivot hole 102. The pressing plate 200 and the handle 101 are oriented in the same direction to facilitate single-handed gripping and pressing actions. A lower portion of the pressing plate 200 abuts against an upper portion of the connection end 301, so that pressing the pressing plate 200 drives the connection end 301 to slide. The spray gun further includes a pumping mechanism 500. The pumping mechanism 500 includes a liquid suction chamber 501. A pump snap-fit 503 is provided at an upper end of the liquid suction chamber 501. A locking cover snap-fit 103 is provided at a lower end of the locking cover mechanism 100. The locking cover snap-fit 103 and the pump snap-fit 503 are engaged to detachably fix the locking cover mechanism 100 to the liquid suction chamber 501. A pump assembly is slidably disposed in the liquid suction chamber 501. An upper end of the pump assembly is in interference fit with the connection end 301. A lower end of the pump assembly abuts against a return spring 507. Pressing the pressing plate 200 drives the connection end 301 to slide downward, and the connection end 301 further drives the pump assembly to slide downward relative to the liquid suction chamber 501 to pump liquid. When pressure is released, the return spring 507 pushes the aforementioned components back to an original position. Repeating the above operations completes the pumping and liquid spraying actions. A cap 600 is rotatably disposed between the locking cover mechanism 100 and the liquid suction chamber 501. An inner side of the cap 600 is provided with convex threads 601, so that the cap 600 can be threadedly connected or snap-fitted to the liquid container. A spray nozzle 700 is detachably sleeved on a front end of the spray rod 302. A spray core 701 is disposed in the spray nozzle 700 to atomize ejected liquid. A foam spray head 400 is detachably sleeved on a front end of the spray nozzle 700. A foam chamber 404 is formed in the foam spray head 400. An air intake hole 401 is provided on a periphery of the foam spray head 400 to communicate the foam chamber 404 with an external environment. Atomized liquid sprayed from the spray nozzle 700 is initially mixed with gas entering through the air intake hole 401 on the side and within the foam chamber 404, blocked by chamber wall of the foam chamber 404. When the liquid contains a certain surfactant, foaming occurs, and foam is sprayed from a front end of the foam spray head 400 to meet application scenarios requiring foam. A foam-flip cover 402 is hinged to a front end of the foam spray head 400. A foam grid 403 is provided on the foam-flip cover 402. Foam sprayed from the front end of the foam spray head 400 is further mixed more fully with air under the obstruction and disturbance of radial grid of the foam grid 403, forming richer foam. The foam is ejected relatively concentratedly through the gap between the radial grid of the foam grid 403, producing more foam to meet application scenarios requiring large amounts of foam.

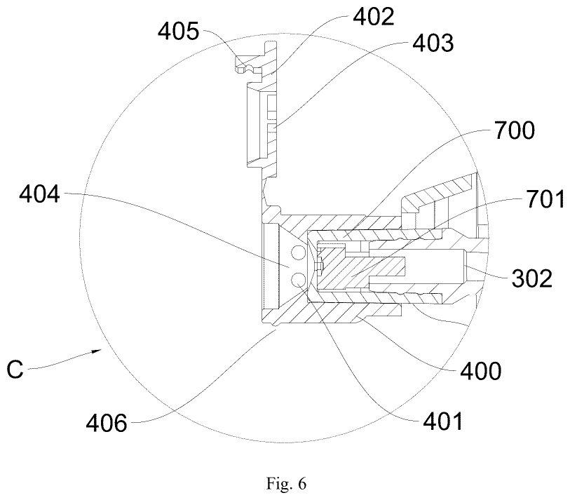

Further referring to FIG. 6, a buckle strip 405 is provided on a periphery of the foam-flip cover 402, and a protrusion 406 is provided on a corresponding position of the periphery of the foam spray head 400 to engage with the buckle strip 405 in a snap-fit connection, enabling the foam-flip cover 402 to be tightly buckled onto the front end of the foam spray head 400.

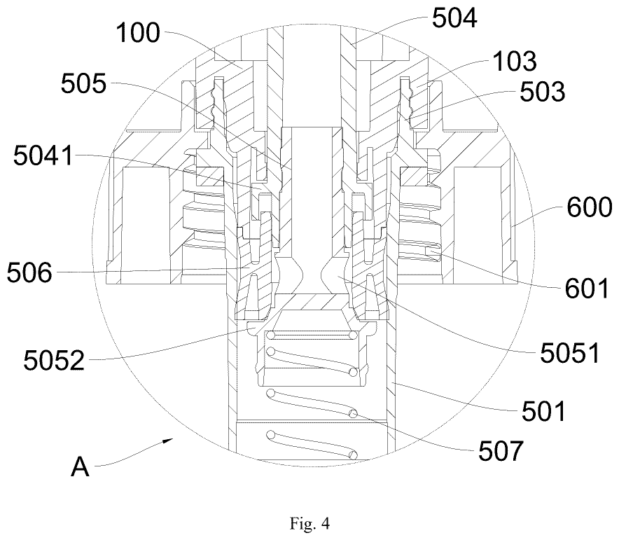

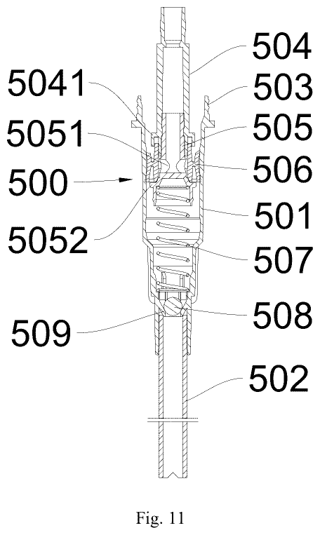

Further referring to FIGS. 4 and 11, the pump assembly includes a first pump column 504, a second pump column 505, and a piston 506. The first pump column 504 is a tubular structure, and an outer wall of an upper end of the first pump column 504 is in interference fit with an inner wall of the connection end 301. A first limiting member 5041 is fixed to the outer wall of the first pump column 504. The second pump column 505 is also a tubular structure, and an outer wall of an upper end of the second pump column 505 is in interference fit with an inner wall of the first pump column 504. A second limiting member 5052 is fixed to the outer wall of the second pump column 505. A bottom end of the second pump column 505 is sealed and abuts against the return spring 507. A liquid inlet 5051 is formed in a side wall of the second pump column 505 to allow liquid to enter a spray liquid passage composed of the second pump column 505, the first pump column 504, and the liquid spraying mechanism 300. The piston 506 is disposed in the liquid suction chamber 501 and performs piston movement. The piston 506 is also slidably sleeved around peripheries of the first pump column 504 and the second pump column 505, located between the first limiting member 5041 and the second limiting member 5052. A sliding stroke of the piston 506 relative to the first pump column 504 and the second pump column 505 equals a distance between the first limiting member 5041 and the second limiting member 5052. The piston 506 is preferably a Y-shaped rubber ring. Liquid is blocked from entering through the liquid inlet 5051 when the piston 506 abuts against the second limiting member 5052, and the return spring 507 biases the second pump column 505 to move upward relative to the piston 506, thereby driving the second limiting member 5052 to abut against the piston 506.

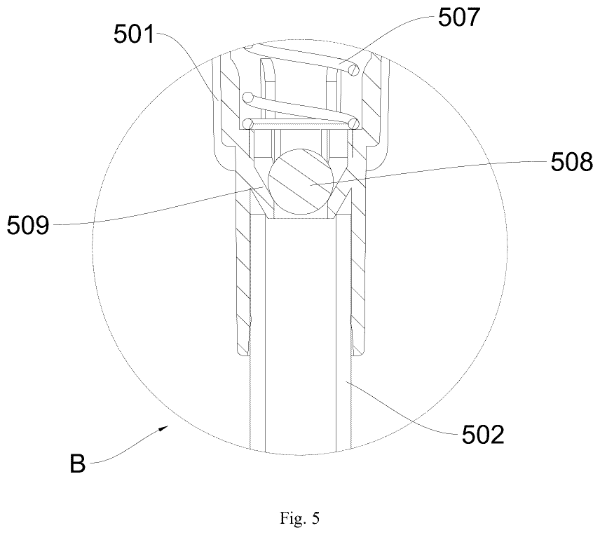

Further referring to FIG. 5, a suction tube 502 is connected to a lower end of the liquid suction chamber 501 and extends to a bottom of the liquid container. A V-shaped orifice 509 is formed at the lower end of the liquid suction chamber 501. A ball valve 508 is movably disposed in the V-shaped orifice 509, wherein a diameter of the ball valve 508 is greater than a diameter of the orifice. When liquid is pumped into the liquid suction chamber 501 due to an internal-external pressure difference, the ball valve 508 is impacted by the liquid and moves upward, clearing the passage of the V-shaped orifice 509. After liquid enters the liquid suction chamber 501 from the suction tube 502, the ball valve 508 falls back into the V-shaped orifice 509 under gravity and blocks the passage, preventing liquid already in the liquid suction chamber 501 from flowing back into the suction tube 502 due to gravity.

Further referring to FIGS. 1-3, the spray gun further includes an external brake clamp 800. The brake clamp 800 can be clipped between the pressing plate 200 and the handle 101 to restrict downward pressing of the pressing plate 200, preventing accidental pressing of the pressing plate 200 during transportation or other situations where use is not required, which could cause liquid to spray out. The spray gun functions normally to spray liquid by pressing the pressing plate 200 after removing the brake clamp 800.

In summary, after removing the brake clamp 800, the spray gun is held single-handedly and the pressing plate 200 is pressed. The pressing plate 200 rotates relative to the locking cover mechanism 100 and drives the connection end 301 to slide downward relative to the locking cover mechanism 100. The connection end 301 further drives the first pump column 504 and the second pump column 505 to slide downward relative to the piston 506, causing the piston 506 to disengage from the second limiting member 5052 and open the passage of the liquid inlet 5051. The first pump column 504 and the second pump column 505 continue to slide downward relative to the piston 506 until the first limiting member 5041 abuts against and drives the piston 506 to move downward relative to the liquid suction chamber 501. At this time, the V-shaped orifice 509 at the lower end of the liquid suction chamber 501 is blocked by the ball valve 508. Gas/liquid inside the liquid suction chamber 501 is squeezed by the piston 506, enters the passage of the first pump column 504 and the second pump column 505 through the liquid inlet 5051, and is sprayed out from the liquid spraying mechanism 300. Subsequently, releasing pressure on the pressing plate 200 allows the second pump column 505, driven by the return spring 507, to move the first pump column 504, the connection end 301, and the pressing plate 200 upward. The second limiting member 5052 abuts against the piston 506 to close the liquid inlet 5051 and drives the piston 506 to move upward. At this time, pressure inside the liquid suction chamber 501 decreases. The suction tube 502 sucks liquid from the liquid container into the liquid suction chamber 501. The ball valve 508 is pushed open by the upward impact force of the liquid, clearing the passage of the V-shaped orifice 509. After gas/liquid enters the liquid suction chamber 501 and pressure balances, the ball valve 508 falls back into the V-shaped orifice 509 under gravity and blocks the passage. Repeating the pressing and releasing actions enables continuous spraying of liquid from the liquid container through the spray rod 302. If the spray nozzle 700 is sleeved on the front end of the spray rod 302 at this time, liquid sprayed from the spray rod 302 is atomized by the spray core 701 and sprayed out as atomized liquid droplets. Further, the foam spray head 400 can be sleeved on the front end of the spray nozzle 700. The atomized liquid droplets mix with gas under the action of the foam spray head 400 to form foam, which is sprayed out as foam. Closing the foam-flip cover 402 at this time can produce more sprayed foam. The present disclosure can be operated single-handedly, is convenient and simple, and can switch between spraying liquid, spraying atomized droplets, or spraying foam modes by switching nozzle components, making the spray gun suitable for various needs in different scenarios.

It will be understood that the present disclosure is described by way of embodiment. Those skilled in the art will appreciate that various changes or equivalent substitutions can be made to these features and embodiments without departing from the spirit and scope of the present disclosure. Furthermore, under the teaching of the present disclosure, modifications can be made to these features and embodiments to adapt to specific situations and materials without departing from the spirit and scope of the present disclosure. Therefore, the present disclosure is not limited by the specific embodiments disclosed herein. All embodiments falling within the scope of the claims of the present disclosure belong to the protection scope of the present disclosure.

What is claimed is:

1. A multifunctional spray gun, comprising:
a locking cover mechanism (100), wherein a handle (101) is fixedly connected to the locking cover mechanism (100);
a liquid spraying mechanism (300), wherein the liquid spraying mechanism (300) comprises a connection end (301) and a spray rod (302) in fluid communication internally, the connection end (301) is slidably disposed in the locking cover mechanism (100), and the spray rod (302) extends outward from the locking cover mechanism (100);
a pressing plate (200), wherein the pressing plate (200) is hinged to the liquid spraying mechanism (300) and abuts against an upper portion of the connection end (301), and the pressing plate (200) and the handle (101) are oriented in the same direction;
a pumping mechanism (500), wherein the pumping mechanism (500) comprises a liquid suction chamber (501), the liquid suction chamber (501) is coaxially fixed to the locking cover mechanism (100), a pump assembly is slidably disposed in the liquid suction chamber (501), an upper end of the pump assembly is in interference fit with the connection end (301), a lower end of the pump assembly abuts against a return spring (507), and the pumping mechanism (500) is configured to perform reciprocating actions for pumping liquid/gas;
a cap (600), wherein the cap (600) is rotatably disposed between the locking cover mechanism (100) and the liquid suction chamber (501), and the cap (600) is detachably connected to a liquid container;
a spray nozzle (700), wherein the spray nozzle (700) is detachably sleeved on a front end of the spray rod (302), and a spray core (701) is disposed in the spray nozzle (700) to atomize ejected liquid; and
a foam spray head (400), wherein the foam spray head (400) is detachably sleeved on a front end of the spray nozzle (700), a foam chamber (404) is formed in the foam spray head (400), and an air intake hole (401) is provided on a periphery of the foam spray head (400) to communicate the foam chamber (404) with an external environment, thereby foaming atomized liquid.

2. The multifunctional spray gun according to claim 1, wherein a foam-flip cover (402) is hinged to a front end of the foam spray head (400), and a foam grid (403) is provided on the foam-flip cover (402) to further foam the atomized liquid.

3. The multifunctional spray gun according to claim 2, wherein a buckle strip (405) is provided on a periphery of the foam-flip cover (402), and a protrusion (406) is provided on a corresponding position of the periphery of the foam spray head (400) to engage with the buckle strip (405) in a snap-fit connection.

4. The multifunctional spray gun according to claim 1, wherein a locking cover snap-fit (103) is provided at a lower end of the locking cover mechanism (100), a pump snap-fit (503) is provided at an upper end of the liquid suction chamber (501), and the locking cover snap-fit (103) and the pump snap-fit (503) are engaged to detachably fix the locking cover mechanism (100) to the liquid suction chamber (501).

5. The multifunctional spray gun according to claim 4, wherein the pump assembly comprises:
a first pump column (504), having a tubular structure, wherein an outer wall of an upper end of the first pump column (504) is in interference fit with an inner wall of the connection end (301), and a first limiting member (5041) is fixed to the outer wall of the first pump column (504);
a second pump column (505), having a tubular structure, wherein an outer wall of an upper end of the second pump column (505) is in interference fit with an inner wall of the first pump column (504), a second limiting member (5052) is fixed to the outer wall of the second pump column (505), a bottom end of the second pump column (505) is sealed and abuts against the return spring (507), and a liquid inlet (5051) is formed in a side wall of the second pump column (505); and
a piston (506), wherein the piston (506) is disposed in the liquid suction chamber (501) and sleeved on the outer walls of the first pump column (504) and the second pump column (505), the piston (506) is positioned between the first limiting member (5041) and the second limiting member (5052), the first pump column (504) and the second pump column (505) are slidable relative to the piston (506), a maximum sliding stroke equals a distance between the first limiting member (5041) and the second limiting member (5052), liquid is blocked from entering through the liquid inlet (5051) when the piston (506) abuts against the second limiting member (5052), and the return spring (507) biases the second pump column (505) to move upward relative to the piston (506), thereby driving the second limiting member (5052) to abut against the piston (506).

6. The multifunctional spray gun according to claim 5, wherein a suction tube (502) is connected to a lower end of the liquid suction chamber (501) and extends to a bottom of the liquid container, a V-shaped orifice (509) is formed at the lower end of the liquid suction chamber (501), and a ball valve (508) is movably disposed in the V-shaped orifice (509), wherein a diameter of the ball valve (508) is greater than a diameter of a lower port of the V-shaped orifice (509).

7. The multifunctional spray gun according to claim 1, wherein the handle (101) and the pressing plate (200) are oriented in the same direction, a pivot hole (102) is provided on the locking cover mechanism (100), a protruding shaft (201) is provided on the pressing plate (200), and the pressing plate (200) is hinged to the locking cover mechanism (100) via engagement between the protruding shaft (201) and the pivot hole (102).

8. The multifunctional spray gun according to claim 7, further comprising: an external brake clamp (800), wherein the brake clamp (800) is clampable between the pressing plate (200) and an upper platform of the handle (101) to restrict depression of the pressing plate (200).
